(19) United States
(12) Patent Application Publication
(10) Pub. No.: US 2009/0064327 A1
(43) Pub. Date: Mar. 5, 2009

(54) Low cost high efficiency anti-phishing method and system called 'safety gates'

(76) Inventor: Igor Igorevich Stukanov, Toronto (CA)

Correspondence Address: IGOR STUKANOV, SUITE 405, 66 OAKMOUNT ROAD, TORONTO, ON, M6P 2M8, CA

(21) Appl. No.: 11/899,159

(22) Filed: Sep. 5, 2007

(51) Int. Cl. G06F 7/04

(52) U.S. Cl. 726/22

(57) ABSTRACT

A low-cost, secure, reliable, convenient, and efficient way to reduce the efficiency of phishing attacks method and system, which consists in putting before login page one or several complimentary login pages, called ‘safety gates’, which lead to web pages with content known only to a legitimate user, who created the online account and pre-loaded digital content displayed after login into the ‘safety gate’.

### CROSS-REFERENCE TO RELATED APPLICATIONS

This patent application refers to the patent application Ser. No. 11/716,733 in several claims.

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Field of the Invention

This invention relates to a method and system, which allow significantly reduce efficiency of phishing attacks by fraudsters.

2. Background Information

Phishing attacks are used by fraudster to commit identity theft or other types of fraud over Internet. In 2006 report on consumer fraud (see http://www.consumer.gov/sentinel/pubs/Top10Fraud2006.pdf) it was reported more than 1.1 bln. loses in USA from fraud with 36% due to identity theft.

Majority of current methods to fight phishing attacks deal with attempts to recognize fraudulent emails, for example using some algorithms to analyze links, domains, IP addresses and informational parts in the e-mail. An example of such method is described in the patent application N 20070044149. In this patent application it is proposed a method which consist in analyzing emails to determine a phishing attack.

A disadvantage of this approach is low accuracy, because domain or IP address in the link may be not recognized as suspicious when it is fraudulent, for example because it is not in the software ‘black list’ of domains (or an IP addresses) or legitimate e-mail is marked as suspicious when there is a similarity in e-mails.

The second group of methods consists in using web browser or some plug in/add in to recognize fraudulent site. There are security toolbars such as SpoofStick, Netcraft Toolbar, PayPal TrustBar, eBay Account Guard, SpoofGuard, but for majority of users they are not very useful.

In PA N 20060080735 is proposed a method, which analyzes web content and compares it with a set of conditions indicative of a phishing attack. In PAs N 20060123464, 20060123478, 20070039038 and 20070033639 are proposed methods, which analyze web domain and network properties of web domain in an attempt to determine a phishing attack.

A disadvantage of the second approach is absence of anti-phishing defense in the cases when a user uses computers with browser not having anti-phishing embedded logic, for example in toolbar, add-in, or internal cod.

The third group of methods consists in analyzing aggregate activity on the site information to determine a phishing attack.

In PA N 20060224511 is proposed a method to analyze aggregate activity on the site information to determine a phishing attack.

A disadvantage of the third approach is low accuracy in the case when phishing attacks are not simultaneous but spreading over long interval of time. In this case aggregate activity will not look suspicious and the attack will not be prevented.

The fourth group of methods consists in sending to users e-mails with pre-designed content by a site operator, which allows e-mail users to distinguish fraudulent e-mails from legitimate e-mails.

In PA N 20070094727 is proposed a method in which a legitimate web site owner send emails to users which contain familiar or known to the users content, which allow them to distinguish fraudulent e-mails from not fraudulent e-mails.

This approach will not work if a user uses mobile devices or software, which not allow seeing this content.

The next disadvantage of this invention is that in the case when a database with such content information will be stolen from the site. In this case fraudsters will be able to successfully carry out a massive phishing attack.

The purpose of the present invention is to suggest the low cost, highly efficient, client software independent anti-phishing method and system, which is free from the drawbacks of the previous approaches and can be implemented by any qualified website operator. The invention is described below.

### BRIEF SUMMARY OF THE INVENTION

An anti-phishing method and system, which consists in putting before login page one or several complimentary login pages, called ‘safety gates’, which lead to web pages with content known only to a legitimate user, who created the online account and pre-loaded digital content displayed after login into the ‘safety gates’. Once the user passed all or a specified number of the ‘safety gates’ successfully the user may login into the account. If at least a one ‘safety gate’ was not passed successfully then the user should leave the site.

### BRIEF DESCRIPTION OF THE SEVERAL VIEWS OF THE DRAWINGS

FIG. 1. A sample of simple user setup setting page

FIG. 2. A sample of an ‘safety gate’ content page on a legitimate site

### DETAILED DESCRIPTION OF THE INVENTION

The present invention is directed to a method and system, which allow significantly reduce efficiency of phishing attacks by fraudsters in low cost way and is described below in one example.

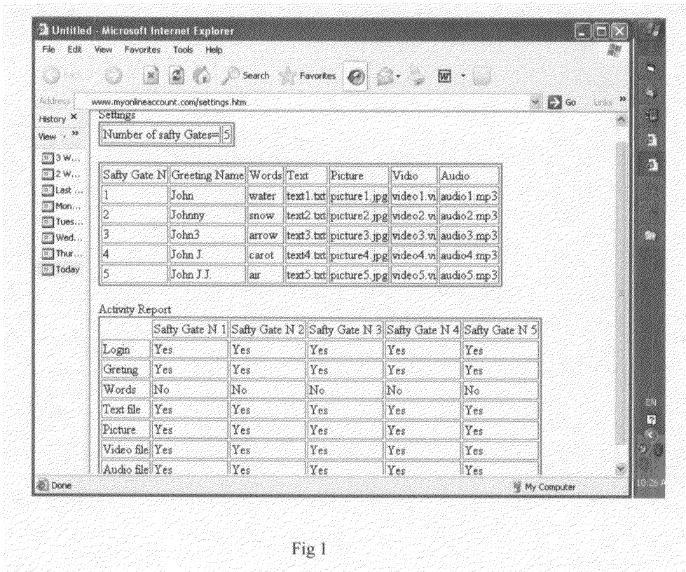

FIG. 1 shows a simplified interface, where a user may select settings for the described in this document anti-phishing system based on ‘safety gates’. The user may select a number of ‘safety gates’ required to safe guard an online account, username and login for each ‘safety gate’, digital content uploaded for each ‘safety gate’, and categories of historical activities displayed on the content pages of the ‘safety gates’. As shown on this figure, the user had selected to setup four ‘safety gates’.

For each ‘safety gate’ the user had selected a text, picture, music file, video file, text file and historical activity related to time of login and changing the content.

A login page to the first ‘safety gate’ looks like the login page into the user's online account. The second and other pages may be similar or may be combined with the content pages corresponding to the previous ‘safety gate’

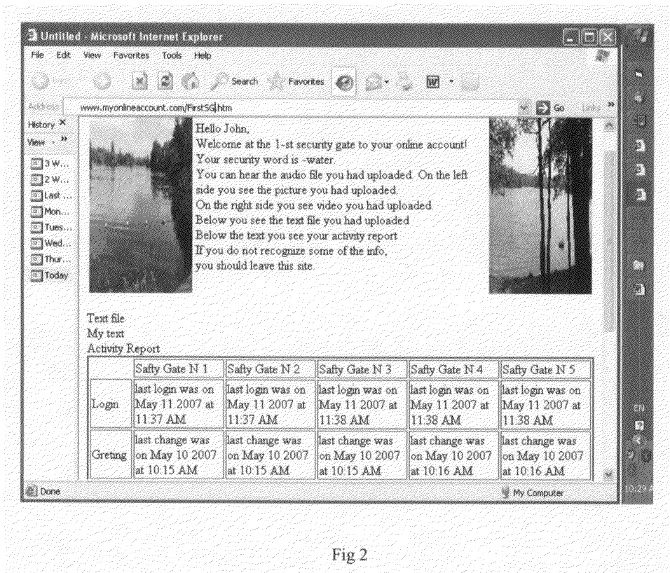

FIG. 2 shows a content page, which is displayed after successful login into the first ‘safety gate’

The method works in the following way:

A web site owner creates ‘safety gates’ pages, content pages, setup pages, and databases for the content data and historical activity data using available web development technologies.

Each user via a setup page creates a login account for each ‘safety gate’ and upload unique only to the user known digital content, which will be displayed on the content pages after successful login into the ‘safety gate’.

When the user visit the website, login into ‘safety gates’ and recognize the content page with digital content, text, and historical activity on all ‘safety pages’, the user may login into the online account safely.

When user visit the website, login into ‘safety gates’ and does not recognize the content page with digital content, text, and historical activity on some ‘safety pages’, the user should not login into the online account, because this may be a fraudulent site.

To compromise such system fraudster need to steal all digital content files and historical activity databases from the company and recreate the web site with anti-phishing system. It will be very hard to steal all digital content even to internal staff if the digital content is stored on geographically separate secure servers. The recreation of such site will be a gigantic work effort. If the company will use a method described in the patent application Ser. No. 11/716,733 to prevent fraud, then the compromised system may be quickly recovered and the impact of fraudster efforts will be minimized.

1. A low-cost, highly efficient, convenient for users method and system for reducing impact of phishing attacks on online users consisting of the following steps:
a. A user selects a number of additional login pages called ‘safety gates’, which are placed before a user login page into the real online account.
b. For each ‘safety gate’ the user creates username and password to use during the login process.
c. The user enters, creates and uploads digital content consisting from text, pictures, video, audio for each ‘safety gate’, which will be displayed on the content page after successful login into the ‘safety gate’. These files are stored securely on one or several geographically distributed servers.
d. The user selects what type of historical activity information should be displayed on the content page. This information is stored securely on one or several geographically distributed servers.
e. After login into the ‘safety gate’ the page with digital content and historical activity information is displayed, which allow the user determine if the site is legitimate.
f. If the user recognizes all digital content and historical activity information she/he may safely login into the next ‘safety gate’.
g. If the user does not recognize something on at least one of content pages she/he must leave the site.
h. After successfully passing all ‘safety gates’ the user may safely login into the online account

2. A method and system as in claim 1, where the content pages are combined with ‘safety gate’ login pages.

3. A method and system as in claim 1, where the current system is in combination with fraud prevention system described in the patent application Ser. No. 11/716,733.

4. A method and system as in claim 2, where the current system is in combination with fraud prevention system described in the patent application Ser. No. 11/716,733
